(19) United States
(12) Patent Application Publication
(10) Pub. No.: US 2026/0296085 A1
(43) Pub. Date: Oct. 1, 2026

(54) SHEET FOR INKJET PRINTING

(71) Applicant: LINTEC CORPORATION, Tokyo (JP)

(72) Inventors: Kamomi MURAKAMI, Koshigaya-shi, Saitama (JP); Takuma OKUBO, Hasuda-shi, Saitama (JP); Tetsuya ARAZOE, Clearwater, FL (US)

(73) Assignee: LINTEC CORPORATION, Tokyo (JP)

(21) Appl. No.: 18/881,774

(22) PCT Filed: Jul. 12, 2022
(86) PCT No.: PCT/JP2022/027395

§ 371 Date: Jan. 7, 2025

(51) Int. Cl. B41M 5/50

(52) U.S. Cl. CPC B41M 5/506; B41M 2205/36

(57) ABSTRACT

An object is to provide a sheet for inkjet printing whereby printing density can be sufficiently ensured while suppressing uneven printing by suppressing variation in interference among dots in an ink-receiving layer surface. This issue may be solved by providing a sheet for inkjet printing, the sheet having a multilayer structure including an ink-receiving layer, a base material, a pressure sensitive adhesive layer, and a release liner in this order. The release liner includes a silicone-based release agent layer on a contact face in contact with the pressure sensitive adhesive layer. The ink-receiving layer is a cured layer of a composition for forming an ink-receiving layer, the composition thereof including a specific energy ray-curable compound (A) and a silicone-based leveling agent (B), and a water contact angle of the ink-receiving layer is 80° or less.

### TECHNICAL FIELD

The present invention relates to a sheet for inkjet printing.

### BACKGROUND ART

An inkjet recording method is a method of making a record where dots are formed by spewing ink droplets and allowing the ink to adhere onto inkjet printing media. The inkjet recording method is rapidly widespread because of its benefits such as the ease of obtaining high quality images in full color, the ease of increasing speed, and low running costs.

Furthermore, with the spread of the inkjet recording method, various proposals are being made for inkjet printing media. For example, a sheet for inkjet printing that can be used as an indoor or outdoor decoration by being attached to a glass or the like and which has a multilayer structure including an ink-receiving layer, a base material, a pressure sensitive adhesive layer, and a release liner in this order has been proposed.

Note that, in the present description, an “ink-receiving layer” is a part where ink for inkjet printing is to be provided and means a layer having a function of fixing a printed portion formed by the provided ink for inkjet printing.

In recent years, various ink-receiving layers have been proposed. For example, an ink-receiving layer containing a vinyl chloride resin and a vinyl acetate resin (see Patent Document 1 and the like) and an ink-receiving layer containing a poly(vinyl butyral) (see Patent Document 2 and the like) are known.

### CITATION LIST

### Patent Literature

Patent Document 1: JP 2019-172877 A
Patent Document 2: JP 2007-130776 A

### SUMMARY OF INVENTION

### Technical Problem

In the course of conducting research and development on ink-receiving layers, the inventors encountered an issue of uneven printing. Specifically, when ink droplets are spewed on an ink-receiving layer by an inkjet recording method and dots are formed, in some areas within the ink-receiving layer surface, dots do not appropriately interfere with each other, variation in interference among dots occurs in the ink-receiving layer surface, and thus printing in the some areas thereof becomes more faint than normal, causing uneven printing to be visible when the entire printed portion formed on the ink-receiving layer is observed, which is an issue.

As a result of intensive studies to solve this issue, the present inventors discovered an issue of a decrease in the printing density of the entire printed portion formed on the ink-receiving layer when an attempt is made to solve the issue of uneven printing.

Thus, difficultly in both suppressing uneven printing and ensuring printing density in the ink-receiving layer has been an issue.

The present invention was developed in light of the issues described above, and an object of the present invention is to provide a sheet for inkjet printing whereby printing density can be sufficiently ensured while also suppressing variation in the interference among dots in an ink-receiving layer surface and suppressing uneven printing.

### Solution to Problem

As a result of intensive studies to solve the above-described issues, the present inventors discovered that the above-described issues can be solved by (1) an ink-receiving layer being a cured layer of a composition for forming an ink-receiving layer containing a specific energy ray-curable compound and a silicone-based leveling agent, and (2) a water contact angle of the ink-receiving layer being set to 800 or less.

That is, the present invention relates to the following aspects [1] to [7] described below.

[1] A sheet for inkjet printing, the sheet having a multilayer structure including an ink-receiving layer, a base material, a pressure sensitive adhesive layer, and a release liner in this order,
the release liner including a silicone-based release agent layer on a contact face in contact with the pressure sensitive adhesive layer,
the ink-receiving layer being a cured layer of a composition for forming an ink-receiving layer, the composition including an energy ray-curable compound (A) and a silicone-based leveling agent (B),
the energy ray-curable compound (A) being an ester of a polyol compound and (meth)acrylic acid, and
a water contact angle of the ink-receiving layer being 800 or less.

[2] The sheet for inkjet printing according to [1], wherein the energy ray-curable compound (A) further satisfies one or more of the following Requirements (X1) to (X3).
Requirement (X1): The ester is a partial ester.
Requirement (X2): The polyol compound constituting the ester is an alkylene oxide-modified product, provided that an alkylene group constituting the alkylene oxide-modified product has from 2 to 4 carbons.
Requirement (X3): The polyol compound constituting the ester has a glycerin skeleton.

[3] The sheet for inkjet printing according to [1] or [2], wherein the composition for forming the ink-receiving layer further includes a filler (C).

[4] The sheet for inkjet printing according to any one of [1] to [3], wherein the sheet is a rolled body obtained by rolling the sheet into a roll form, or is a wound body obtained by winding the sheet around a core material.

[5] A method of use including using the sheet for inkjet printing described in any one of [1] to [4] to form, on an ink-receiving layer of the sheet for inkjet printing, a printed portion by using an ink for inkjet printing.

[6] A method for producing a printed article, the method including forming a printed portion on an ink-receiving layer of the sheet for inkjet printing described in any one of claims 1 to 4 by using an ink for inkjet printing.

[7] A printed article, including a printed portion formed by an ink for inkjet printing, the printed portion being formed on an ink-receiving layer of the sheet for inkjet printing described in any one of claims 1 to 4.

### Advantageous Effects of Invention

According to the present invention, a sheet for inkjet printing whereby printing density can be sufficiently ensured while suppressing uneven printing by suppressing variation in the interference among dots in an ink-receiving layer surface can be provided.

### BRIEF DESCRIPTION OF DRAWINGS

FIG. 1 is a schematic cross-sectional view illustrating an example of a sheet for inkjet printing according to an aspect of the present invention.

FIG. 2 is a schematic cross-sectional view illustrating a multilayer state of two sheets for inkjet printing in a pretreatment carried out before evaluations (2) and (3) in the Examples.

### DESCRIPTION OF EMBODIMENTS

In the present description, “active components (solid content)” refer to components excluding a diluent solvent, such as water or an organic solvent, from the components contained in a target composition.

In the present description, “(meth)acrylate” means both methacrylate and acrylate, and the same applies to similar terminologies. For example, the term (meth)acrylic acid means both methacrylic acid and acrylic acid, and the term (meth)acryloyl group means both a methacryloyl group and an acryloyl group.

In the present specification, the lower and upper limits of a preferable numerical range (for example, a range of content) described in series can each be independently combined. For example, from the description “preferably from 10 to 90, more preferably from 30 to 60”, the “preferred lower limit (10)” and the “more preferred upper limit (60)” can be combined as “from 10 to 60”.

In the present description, the numerical values of examples are numerical values that can be used as an upper limit value or a lower limit value.

### Aspect of Sheet for Inkjet Printing of the Present Invention

The sheet for inkjet printing according to an embodiment of the present invention has a multilayer structure including in this order an ink-receiving layer, a base material, a pressure sensitive adhesive layer, and a release liner.

The release liner has a silicone-based release agent layer on a contact face in contact with the pressure sensitive adhesive layer.

The ink-receiving layer is a cured layer of a composition for forming an ink-receiving layer, the composition thereof including an energy ray-curable compound (A) and a silicone-based leveling agent (B).

The energy ray-curable compound (A) is an ester of a polyol compound and (meth)acrylic acid.

Moreover, the ink-receiving layer has a water contact angle of 80° or less.

The inventors of the present invention conducted diligent examinations to solve the issues described above. As a result, the inventors discovered that by blending a silicone-based leveling agent into the ink-receiving layer, variation in the interference among dots in the ink-receiving layer surface is suppressed, and uneven printing can thereby be suppressed.

However, it was found that when a silicone-based leveling agent is blended into the ink-receiving layer to suppress uneven printing, the printing density of the overall printed portion formed on the ink-receiving layer decreases.

Thus, to mitigate this issue, the inventors of the present invention conducted further intensive examinations. As a result, the inventors discovered that when the ink-receiving layer is a cured layer of a composition for forming an ink-receiving layer with the composition containing the above-mentioned specific energy ray-curable compound (A) and the silicone-based leveling agent (B), and the water contact angle of the ink-receiving layer is adjusted to 80° or less, the printing density can be sufficiently ensured while suppressing uneven printing.

The mechanism by which the effects of the present invention are exhibited is not clear, but is presumed to be as follows.

That is, by forming the sheet for inkjet printing having the above-mentioned multilayer structure into a rolled body rolled into a roll form, or into a wound body wound around a core material, when the ink-receiving layer and the back surface of a release liner are brought into contact, an extremely small amount of the silicone component transfers onto the ink-receiving layer surface. As a result, a partial change in surface free energy occurs in the ink-receiving layer surface. In the region where the partial change in surface free energy occurs, the interference among dots becomes less than usual due to decrease in wettability of dots with respect to the ink-receiving layer compared to a region where the change in surface free energy is not occurring. This phenomenon can inhibit the appropriate interference that should occur among dots and results in the printed portion becoming faint. It is presumed that uneven printing becomes visible because the printed portion is light in a region where the surface energy is changed, whereas the printed portion is of a standard darkness in a region where the surface free energy is not changed. The uneven printing is suppressed by suppressing variation in the interference among dots in the ink-receiving layer surface by blending a silicone-based leveling agent in the ink-receiving layer. It is presumed that the effect of suppressing uneven printing is exhibited by blending the silicone-based leveling agent into the ink-receiving layer to thereby prevent coexistence in the ink-receiving layer surface of a region where the silicone component is excessively present and a region where the silicone component is not present at all. In other words, it is presumed that the effect of suppressing uneven printing is achieved by the making the surface free energy uniform in the ink-receiving layer surface.

Meanwhile, when the silicone-based leveling agent is blended in the ink-receiving layer, the wettability of the entire ink-receiving layer decreases, making it difficult for the dots to wet and spread over the entire ink-receiving layer. As a result, the printing density of the entire printed portion formed on the ink-receiving layer is reduced. Therefore, the ink-receiving layer is formed as a cured layer of a composition for forming an ink-receiving layer, the composition containing the specific energy ray-curable compound (A) and the silicone-based leveling agent (B), and the water contact angle of the ink-receiving layer is adjusted to 80° or less. As a result, the wettability of the entire ink-receiving layer is improved, the dots are easily wetted and spread, and the effect of suppressing uneven printing while ensuring sufficient printing density is sufficiently exhibited.

Regarding the sheet for inkjet printing according to an embodiment of the present invention, configuration of the sheet for inkjet printing, an ink-receiving layer, a base material, a pressure sensitive adhesive layer, and a release liner constituting the sheet for inkjet printing, a method for producing the sheet for inkjet printing, and use of the sheet for inkjet printing will be described in detail described below.

### Configuration of Sheet for Inkjet Printing

The sheet for inkjet printing according to an embodiment of the present invention has a multilayer structure including in this order an ink-receiving layer, a base material, a pressure sensitive adhesive layer, and a release liner.

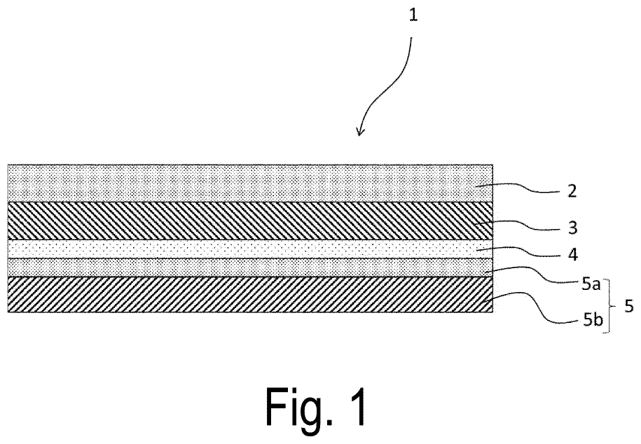

FIG. 1 illustrates a schematic cross-sectional view of one aspect of the sheet for inkjet printing according to an embodiment of the present invention. The sheet for inkjet printing 1 illustrated in FIG. 1 has a multilayer structure including an ink-receiving layer 2, a base material 3, a pressure sensitive adhesive layer 4, and a release liner 5 in this order. Furthermore, the release liner 5 includes a silicone-based release agent layer 5a and a support 5b, and the silicone-based release agent layer 5a is in contact with the pressure sensitive adhesive layer 4.

Note that, in the sheet for inkjet printing 1 illustrated in FIG. 1, the ink-receiving layer 2, the base material 3, the pressure sensitive adhesive layer 4, and the release liner 5 are laminated directly without interposing another layer. Thus, the sheet for inkjet printing 1 illustrated in FIG. 1 consists only of the ink-receiving layer 2, the base material 3, the pressure sensitive adhesive layer 4, and the release liner 5.

However, the sheet for inkjet printing 1 is not necessarily limited to such an embodiment. For example, another layer may be optionally provided at least in between the ink-receiving layer 2 and the base material 3 or in between the base material 3 and the pressure sensitive adhesive layer 4. Examples of another layer include adhesion promoting layer.

Furthermore, although the silicone-based release agent layer 5a and the support 5b may be directly laminated as illustrated in FIG. 1, another layer may be optionally provided in between the silicone-based release agent layer 5a and the support 5b. Examples of another layer include a filler layer.

### Ink-Receiving Layer

In the sheet for inkjet printing of the present invention, the ink-receiving layer is a cured layer of a composition for forming an ink-receiving layer, the composition thereof containing an energy ray-curable compound (A) and a silicone-based leveling agent (B), and the ink-receiving layer has a water contact angle of 80° or less. Through this configuration, printing density can be sufficiently ensured while suppressing uneven printing by suppressing variation in the interference among dots in the ink-receiving layer surface.

### Water Contact Angle of Ink-Receiving Layer

In the present invention, the water contact angle of the ink-receiving layer must be 80° or less.

When the water contact angle of the ink-receiving layer is 81° or greater, the wettability of the ink-receiving layer cannot be sufficiently ensured, and the dots are not easily wetted and spread, resulting in a decrease in printing density.

Here, from the viewpoint of easily ensuring a sufficient printing density, the water contact angle of the ink-receiving layer is preferably 79° or less, and more preferably 78° or less.

The lower limit of the water contact angle of the ink-receiving layer is not particularly limited, but is usually, for example, 58° or greater in consideration of details such as the configuration of the ink-receiving layer.

In the present specification, the water contact angle of the ink-receiving layer means a value measured by a method described in the Examples described below. Moreover, the location at which the water contact angle is to be measured is the location on the ink-receiving layer where the ink for inkjet printing is applied.

The water contact angle of the ink-receiving layer can be adjusted by adjusting details such as the types and contents of the energy ray-curable compound (A) and silicone-based leveling agent (B) contained in the composition for forming the ink-receiving layer.

The energy ray-curable compound (A), the silicone-based leveling agent (B), and the like are described in detail described below based on the method for adjusting the water contact angle of the ink-receiving layer.

### Energy Ray-Curable Compound (A)

In the present invention, the composition for forming an ink-receiving layer contains an energy ray-curable compound (A). When the composition for forming an ink-receiving layer does not contain the energy ray-curable compound (A), it becomes difficult to adjust the water contact angle of the ink-receiving layer to 80° or less and ensure a sufficient printing density. In addition, increasing the surface hardness of the ink-receiving layer and suppressing scratching during attachment or use are facilitated.

Herein, the term “energy ray-curable compound” refers to a compound that is cured (polymerized) by irradiation with energy rays. Therefore, the ink-receiving layer contains a polymer (resin) derived from the energy ray-curable compound (A).

Moreover, the term “energy rays” means electromagnetic waves or charged particle beams having energy quanta, examples of which include ultraviolet rays or electron beams, with ultraviolet rays being preferable.

In the present invention, the energy ray-curable compound (A) is an ester of a polyol compound and (meth)acrylic acid.

When the energy ray-curable compound (A) is a compound other than an ester of a polyol compound and (meth)acrylic acid, it is difficult to adjust the water contact angle of the ink-receiving layer to 80° or less, and ensuring sufficient printing density becomes difficult.

One type of energy ray-curable compound (A) may be used alone, or two or more types of energy ray-curable compounds may be used in combination.

Examples of the energy ray-curable compound (A) include polymerizable compounds having one or more (meth)acryloyl groups per molecule.

Here, from the viewpoint of easily improving the effect of the present invention, the energy ray-curable compound (A) preferably has two or more (meth)acryloyl groups per molecule, and more preferably has from 2 to 6 (meth)acryloyl groups per molecule.

The polyol compound constituting the energy ray-curable compound (A) is preferably a polyol having a valence of from 2 to 10, and is more preferably a polyol having valence of from 3 to 6. In addition, the polyol compound may be an alkylene oxide-modified product. Therefore, preferable examples of the polyol compound are alkylene oxide-modified products of a polyol having a valence of from 2 to 10, and more preferable examples of the polyol compound are alkylene oxide-modified products of a polyol having a valence of from 3 to 6.

Note that the number of carbons of the alkylene group constituting the alkylene oxide-modified product is preferably from 2 to 4, more preferably from 2 to 3, and still more preferably 2.

Specific examples of preferable polyol compounds include polyols such as trimethylolethane, trimethylolpropane, trimethylolbutane, di-trimethylolpropane, tri-trimethylolpropane, pentaerythritol, dipentaerythritol, tripentaerythritol, glycerin, polyglycerin (a multimer of glycerin, preferably from a dimer to a decamer of glycerin, more preferably from a dimer to a hexamer of glycerin, and even more preferably from a trimer to a pentamer of glycerin), 1,3,5-pentanetriol, sorbitol, adonitol, arabitol, xylitol, and mannitol; and alkylene oxide-modified products (preferably ethylene oxide-modified products) of these polyols.

Here, from the viewpoint of more easily adjusting the water contact angle of the ink-receiving layer to 80° or less, the energy ray-curable compound (A) preferably satisfies one or more of the following requirements (X1) to (X3).
Requirement (X1): The ester is a partial ester.
Requirement (X2): The polyol compound constituting the ester is an alkylene oxide-modified product. Moreover, the alkylene group constituting the alkylene oxide-modified product has from 2 to 4 carbons.
Requirement (X3): The polyol compound constituting the ester has a glycerin skeleton.

An ester formed from a polyol compound and (meth)acrylic acid and satisfying the requirement (X1) has a high hydroxyl value and tends to be highly hydrophilic, and therefore the water contact angle of the ink-receiving layer can be easily adjusted to 80° or less.

Here, from the viewpoint of further increasing the hydrophilicity and facilitating adjustment of the water contact angle of the ink-receiving layer to 80° or less, the hydroxyl value of the partial ester of the polyol compound and (meth)acrylic acid is preferably 50 mgKOH/g or greater, more preferably 70 mgKOH/g or greater, and still more preferably 80 mgKOH/g or greater.

In the present specification, the hydroxyl value means a value measured in accordance with JIS K 0070:1992.

An ester formed from a polyol compound and (meth)acrylic acid and satisfying the above-described requirement (X2) tends to be highly hydrophilic, and therefore the water contact angle of the ink-receiving layer can be easily adjusted to 80° or less.

The ester satisfying the above-described requirement (X2) may be a complete ester or a partial ester.

When the ester satisfying the requirement (X2) is a partial ester, the requirement (X1) is also satisfied. Note that the number of carbons of the alkylene group constituting the alkylene oxide-modified product is preferably from 2 to 4, more preferably from 2 to 3, and still more preferably 2.

The number (number of moles) of alkylene oxide per molecule is not limited, but from the viewpoint of increasing the hydrophilicity of the ester of the polyol compound and the (meth)acrylic acid and easily adjusting the water contact angle of the ink-receiving layer to 80° or less, the number of moles thereof is preferably 4.0 or more, more preferably 5 or more, and still more preferably 6 or more.

An ester formed from a polyol compound and (meth)acrylic acid and satisfying the above-described requirement (X3) tends to be highly hydrophilic, and therefore the water contact angle of the ink-receiving layer can be easily adjusted to 80° or less.

The ester satisfying the above-described requirement (X3) may be a complete ester or a partial ester.

When the ester satisfying the requirement (X3) is a partial ester, the requirement (X1) is also satisfied.

Note that a polyol compound having a glycerin skeleton means glycerin or polyglycerin. As described above, polyglycerin means a multimer of glycerin, and is preferably from a dimer to a decamer of glycerin, more preferably from a dimer to a hexamer of glycerin, even more preferably from a trimer to a pentamer of glycerin, and still further preferably a tetramer of glycerin.

In one aspect of the present invention, the content of the energy ray-curable compound (A) is appropriately adjusted so that the water contact angle of the ink-receiving layer can be adjusted to 80° or less.

When the content of the energy ray-curable compound (A) in the composition for forming an ink-receiving layer is increased, the water contact angle of the ink-receiving layer is decreased. Conversely, when the content of the energy ray-curable compound (A) in the composition for forming an ink-receiving layer is decreased, the water contact angle of the ink-receiving layer is increased. Based on this tendency, from the viewpoint of a balance with the blending amount of the silicone-based leveling agent (B), the content of the energy ray-curable compound (A) is adjusted so that the water contact angle of the ink-receiving layer can be adjusted to 80° or less.

### Silicone-Based Leveling Agent (B)

In the present invention, the ink-receiving layer and the composition for forming the ink-receiving layer contain a silicone-based leveling agent (B). When the ink-receiving layer and the composition for forming the ink-receiving layer do not contain a silicone-based leveling agent (B), uneven printing cannot be suppressed.

Note that it is presumed that the silicone-based leveling agent (B) has an action of suppressing partial disorder in the surface free energy of the ink-receiving layer surface caused by a silicone component transferred from the release liner back surface to the ink-receiving layer, achieving uniformity of the surface free energy in the ink-receiving layer surface, and suppressing variation in interference among dots in the ink-receiving layer surface. It is conceived that this action suppresses uneven printing.

The silicone-based leveling agent (B) is a compound having a siloxane backbone, and specific examples thereof include at least one type selected from the group consisting of compounds having a siloxane backbone and an organic functional group and compounds having a siloxane backbone and an organically-modified group. Note that the organically-modified group means a group in which some organic functional groups are replaced with other groups.

Specific examples of the silicone-based leveling agent (B) include polyether-modified silicone oils such as DOWSIL (trade name) BY16-036 Fluid, DOWSIL SH28 Paint Additive, DOWSIL SF8428 Fluid, DOWSIL 501W Additive, DOWSIL L-7001 Fluid, DOWSIL FZ-2104 Fluid, DOWSIL L-7002 Fluid, and DOWSIL SF8427 Fluid (available from Dow Toray Co., Ltd.); alkyl-modified silicone oils such as DOWSIL (trade name) SF8416 Fluid, DOWSIL BY16-846 Fluid, DOWSIL SH203 Fluid, and DOWSIL 56 Additive (available from Dow Toray Co., Ltd.); carboxyl-modified silicone oils such as DOWSIL (trade name) BY-16-880 and DOWSIL BY16-750 Fluid (available from Dow Toray Co., Ltd.); amino-modified silicone oils such as XIAMETER (trade name) OFX-8417 Fluid, DOWSIL (trade name) BY-16-849 Fluid, DOWSIL FZ-3785 Fluid, DOWSIL 16-872 Fluid, and DOWSIL 16-853U Fluid (available from Dow Toray Co., Ltd.); and epoxy-modified silicone oils such as DOWSIL (trade name) SF8413 Fluid, DOWSIL SF8411 Fluid, DOWSIL BY16-839 Fluid, DOWSIL FZ-3736 Fluid, DOWSIL SF8421 EG Fluid, DOWSIL BY16-870 Fluid, DOWSIL BY16-876 Fluid, DOWSIL BY16-869 Fluid, and DOWSIL BY16-760 Fluid (available from Dow Toray Co., Ltd.).

Among these, a polyether-modified silicone oil is more preferred.

One type of the silicone-based leveling agent (B) may be used alone, or a combination of two or more types of the silicone-based leveling agent (B) may be used.

In one aspect of the present invention, the content of the silicone-based leveling agent (B) in the composition for forming an ink-receiving layer is appropriately adjusted so that uneven printing can be suppressed and the water contact angle of the ink-receiving layer can be adjusted to 80° or less.

When the content of the silicone-based leveling agent (B) in the composition for forming the ink-receiving layer is increased, the water contact angle of the ink-receiving layer increases. Conversely, when the content of the silicone-based leveling agent (B) in the composition for forming the ink-receiving layer is decreased, the water contact angle of the ink-receiving layer decreases. Based on this tendency, from the viewpoint of achieving a balance with the effect of improving the hydrophilicity of the ink-receiving layer using the energy ray-curable compound (A), the content of the silicone-based leveling agent (B) is adjusted so that the water contact angle of the ink-receiving layer can be adjusted to 80° or less.

As examples of the content of the silicone-based leveling agent (B), the content thereof is preferably from 0.01 parts by mass to 0.06 parts by mass, and more preferably from 0.02 parts by mass to 0.05 parts by mass, per 100 parts by mass of the energy ray-curable compound (A). Moreover, as an example of the content of the silicone-based leveling agent (B) per 1 m² of the ink-receiving layer, the content thereof is preferably from 0.12 mg/m² to 1.0 mg/m², and more preferably from 0.27 mg/m² to 0.75 mg/m².

### Filler (C)

In one aspect of the present invention, the ink-receiving layer and the composition for forming the ink-receiving layer preferably further contain a filler (C).

When the ink-receiving layer and the composition for forming the ink-receiving layer contain the filler (C), the slipperiness of the ink-receiving layer surface can be improved, and the transportability of a sheet for inkjet printing can be easily improved.

Note that “improvement in transportability” means an improvement in slipperiness between sheets for inkjet printing and in slipperiness between a sheet for inkjet printing and a device (roller or cylinder). Through such improvements, rolling, feeding out, and the like of sheets for inkjet printing can be favorably implemented, and the occurrence of issues such as wrinkles or scratches in the sheet and printing position deviations can be easily suppressed.

Examples of the filler (C) include silica, alumina, titania, and zirconia oxide, and silica is preferable from the viewpoint of the transparency of the ink-receiving layer being less likely to be impaired.

The particle size of the filler (C) is preferably from 10 nm to less than 1 μm, more preferably from 10 nm to 500 nm, and even more preferably from 10 nm to 100 nm.

When the particle size of the filler (C) is within the above-described range, the effect of improving the slipperiness of the ink-receiving layer surface and facilitating an improvement in the transportability of the sheet for inkjet printing is easily obtained, and the transparency of the ink-receiving layer is less likely to be impaired.

The particle size of the filler (C) is an average primary particle size converted from the specific surface area obtained by the BET method.

The filler (C) that is used may be in the form of a dry powder, but is preferably dispersed in an organic solvent to form a colloidal solution from the viewpoint of dispersion stability.

A single type of the filler (C) may be used alone, or a combination of two or more types of fillers (C) may be used.

In one aspect of the present invention, the content of the filler (C) in the composition for forming the ink-receiving layer is not particularly limited, but from the viewpoint of improving the slipperiness of the ink-receiving layer surface and improving the transportability of the sheet for inkjet printing and from the viewpoint of being less likely to impair the transparency of the ink-receiving layer, the content of the filler (C) is preferably from 20 to 500 parts by mass, more preferably from 30 to 300 parts by mass, even more preferably from 40 to 200 parts by mass, and yet even more preferably from 50 to 150 parts by mass, per 100 parts by mass of the energy ray-curable compound (A).

### Photopolymerization Initiator (D)

In one aspect of the present invention, the ink-receiving layer and the composition for forming the ink-receiving layer preferably contain a photopolymerization initiator (D). When the composition for forming an ink-receiving layer contains the photopolymerization initiator (D) together with the energy ray-curable compound (A), progression of energy ray curing by ultraviolet rays or the like can be facilitated.

As the photopolymerization initiator (D), a general compound having a function of facilitating energy ray curing by ultraviolet rays or the like can be used without particular limitation. Examples of such compounds include 1-hydroxycyclohexyl phenyl ketone, benzoin, benzoin methyl ether, benzoin ethyl ether, benzoin isopropyl ether, benzyl diphenyl sulfide, tetramethylthiuram monosulfide, azobisisobutyronitrile, benzyl, dibenzyl, diacetyl, β-chloroanthraquinone, bis(2,4,6-trimethylbenzoyl)phenylphosphine oxide, 2,4,6-trimethylbenzoyldiphenylphosphine oxide, bis(2,6-dimethoxybenzoyl)-2,4,4-trimethyl-pentylphosphine oxide, and 2-hydroxy-1-{4-[4-(2-hydroxy-2-methyl-propionyl)-benzyl]phenyl}-2-methylpropan-1-one.

One type of the photopolymerization initiator (D) may be used alone, or two or more types may be used in combination.

In one aspect of the present invention, the content of the photopolymerization initiator (D) in the composition for forming an ink-receiving layer is not particularly limited, but is preferably from 0.1 to 10 parts by mass per 100 parts by mass of the energy ray-curable compound (A).

### Other Additives

In one aspect of the present invention, the composition for forming an ink-receiving layer may contain another component besides the energy ray-curable compound (A), the silicone-based leveling agent (B), the filler (C), and the photopolymerization initiator (D) within a range in which the water contact angle of the ink-receiving layer can be adjusted to 80° or less, or the composition for forming an ink-receiving layer may not contain another component.

For example, the composition for forming an ink-receiving layer may or may not contain an energy ray-curable compound (A′) other than the energy ray-curable compound (A) within a range in which the water contact angle of the ink-receiving layer can be adjusted to 80° or less.

### Base Material

The sheet for inkjet printing according to an embodiment of the present invention includes a base material.

The base material supports the sheet for inkjet printing and has a function as a support supporting the printed portion formed on the ink-receiving layer.

The base material is not particularly limited, and is preferably a resin sheet. When the base material is a resin sheet, excellent rigidity, flexibility, and the like of the sheet for inkjet printing and excellent handling of the sheet for inkjet printing are achieved. This is also advantageous from the viewpoint of reducing the production cost and weight of the sheet for inkjet printing.

Examples of the resin constituting the resin sheet include polyester resins such as polyethylene terephthalate, polybutylene terephthalate, and polyethylene naphthalate; polyolefin resins such as polyethylene and polypropylene; polystyrene; acrylonitrile-butadiene-styrene copolymers; cellulose triacetate; polycarbonate; urethane resins such as polyurethane and acrylic-modified polyurethane; polymethylpentene; polysulfone; polyether ether ketone; polyethersulfone; polyphenylene sulfide; polyimide resins such as polyetherimide and polyimide; polyamide resins; acrylic resins; and fluorine resins.

Among these, polyester resins and polyolefin resins are preferable, polyester resins are more preferable, and polyethylene terephthalate is even more preferable from the viewpoint of improvement in adhesion with the ink-receiving layer.

The resin sheet may be formed of only one kind of resin, or may be formed of two or more kinds of resins. When the resin sheet is formed of two or more kinds of resins, the resin sheet is preferably a multilayer body. Furthermore, the uppermost layer of the multilayer body (the layer in contact with the ink-receiving layer) is preferably a polyester resin, and more preferably polyethylene terephthalate, from the viewpoint of improvement in adhesion with the ink-receiving layer.

The resin sheet may be unstretched, or may be stretched in a uniaxial direction such as a longitudinal direction or a lateral direction, or a biaxial direction.

In addition, the resin sheet may contain an additive for a base material such as a surface conditioner, a plasticizer, an ultraviolet absorber, a light stabilizer, and a colorant together with these resins.

A content of the additive for the base material is preferably 10 mass % or less, more preferably 5 mass % or less, and even more preferably 3 mass % or less, with respect to the total amount of the base material.

A thickness of the base material is not particularly limited and is preferably from μm to 300 μm, and more preferably from 30 μm to 200 μm.

### Pressure Sensitive Adhesive Layer

The sheet for inkjet printing according to an embodiment of the present invention includes a pressure sensitive adhesive layer.

By allowing the sheet for inkjet printing according to an embodiment of the present invention to have the pressure sensitive adhesive layer, the sheet for inkjet printing can be suitably used as a pressure sensitive adhesive sheet.

The pressure sensitive adhesive constituting the pressure sensitive adhesive layer is not particularly limited, and examples thereof include acrylic pressure sensitive adhesives and urethane pressure sensitive adhesives. When the sheet for inkjet printing is used for window display and the like, from the viewpoint of weatherability and the like, the pressure sensitive adhesive layer may be made of an acrylic pressure sensitive adhesive. Furthermore, in a case in which removability from an adherend is required, the pressure sensitive adhesive layer may be made of a urethane-based pressure sensitive adhesive.

The pressure sensitive adhesive layer may contain other components such as ultraviolet absorbers, tackifiers, antioxidants, light stabilizers, softeners, silane coupling agents, and fillers, as necessary. One type of these may be used alone, or two or more types of these may be mixed and used.

A thickness of the pressure sensitive adhesive layer is not particularly limited, and is preferably 5 μm to 100 μm, more preferably 10 μm to 70 μm, and even more preferably 15 μm to 50 μm, from the viewpoint of improving the handleability when the sheet for inkjet printing is used as a pressure sensitive adhesion sheet.

### Release Liner

The sheet for inkjet printing according to an embodiment of the present invention includes a release liner.

The pressure sensitive adhesion surface of the pressure sensitive adhesive layer included in the sheet for inkjet printing according to an embodiment of the present invention is covered with a release liner, and thus the pressure sensitive adhesion surface of the pressure sensitive adhesive layer can be suitably protected during transportation and storage of the sheet for inkjet printing.

Note that, in the sheet for inkjet printing according to an embodiment of the present invention, the release liner has a silicone-based release agent layer. When the sheet is formed into a rolled body or a wound body, an extremely small amount of the silicone component of the release liner may transfer to the release liner back surface. Thus, when the sheet for inkjet printing having the multilayer structure is formed into a rolled body or a wound body, an extremely small amount of the silicone component present in the release liner back surface may transfer to the ink-receiving layer.

The silicone component transferred from the release liner back surface to the ink-receiving layer causes partial disorder in surface free energy in the ink-receiving layer surface. As a result, variation in interference among dots occurs in the ink-receiving layer surface, and uneven printing occurs. However, according to the present invention, by blending the silicone-based leveling agent (B) into the ink-receiving layer and the composition for forming the ink-receiving layer, partial disorder in the surface free energy of the ink-receiving layer surface is suppressed, the surface free energy in the ink-receiving layer surface is made uniform, and variation of interference among dots in the ink-receiving layer surface is suppressed, and thus uneven printing can be suppressed.

In addition, by setting the water contact angle of the ink-receiving layer to 80° or less, a decrease in printing density caused by blending the silicone-based leveling agent (B) is also suppressed, and the printing density can be sufficiently ensured.

As the silicone-based release agent layer constituting the release liner, those ordinarily used for a release liner can be used without particular limitation.

Examples of the support constituting the release liner include sheet or paper that is ordinarily used for release liners.

Examples of the sheet include polyester resins such as polyethylene terephthalate, and polyolefin resins such as polyethylene resins and polypropylene resins.

Examples of the paper include papers such as wood-free paper, kraft paper, and glassine paper.

A thickness of the release liner is not particularly limited, and is preferably 10 μm to 150 μm, more preferably 20 μm to 130 μm, and even more preferably 30 μm to 120 μm.

### Method for Producing Sheet for Inkjet Printing

The method for producing the sheet for inkjet printing according to an embodiment of the present invention is not particularly limited, and is appropriately selected depending on the configuration of the sheet for inkjet printing.

A method for forming the ink-receiving layer preferably includes applying the composition for forming an ink-receiving layer, the composition thereof containing the energy ray-curable compound (A) and the silicone-based leveling agent (B), to one surface of the base material to form a coating, drying the coating, and then curing the coating.

As described above, the composition for forming an ink-receiving layer preferably further contains a filler (C). Moreover, the composition for forming an ink-receiving layer preferably further contains a photopolymerization initiator (D) as described above.

Note that, in order to improve the workability of application to the base material, the composition for forming an ink-receiving layer is preferably diluted with a diluent solvent to form a solution.

Examples of the diluent solvent include organic solvents such as methyl ethyl ketone, acetone, ethyl acetate, tetrahydrofuran, dioxane, cyclohexane, n-hexane, toluene, xylene, n-propanol, and isopropanol.

An active component (solid content) concentration of a solution of the composition for forming an ink-receiving layer is preferably from 10 mass to 50 mass %.

Examples of the method for applying the solution of the composition for forming an ink-receiving layer include a bar coating method, a gravure coating method, a roll coating method, a knife coating method, and a die coating method.

A heating condition for drying the coating is, for example, a drying temperature of 60° C. to 120° C. and a drying time of 30 seconds to 3 minutes.

After the coating has been dried, the coating is irradiated with energy rays (preferably ultraviolet rays) to cure (polymerize) the energy ray-curable compound (A).

When ultraviolet rays are used as the energy rays, an irradiation condition of the ultraviolet rays is that the cumulative radiation dose (cumulative dose) is preferably from 5 to 1200 mJ/cm², and more preferably from 30 to 500 mJ/cm².

The ultraviolet rays can be irradiated by using, for example, a high-pressure mercury lamp, an electrodeless lamp, a xenon lamp, or an LED as an ultraviolet ray source.

The pressure sensitive adhesive layer contained in the sheet for inkjet printing of an aspect of the present invention is formed on another surface, in which the ink-receiving layer is not formed, of the base material.

For example, a composition for forming the pressure sensitive adhesive layer is applied on the other surface of the base material and thus the pressure sensitive adhesive layer is formed, and a release liner is laminated on the pressure sensitive adhesive layer. Alternatively, the composition for forming a pressure sensitive adhesive layer may be applied to the release surface (surface of the silicone-based release agent layer) of the release liner to form the pressure sensitive adhesive layer, and the pressure sensitive adhesive layer may be bonded to the other surface of the base material.

The method for applying the composition for forming a pressure sensitive adhesive layer is the same as that described above as the method for applying the composition for forming an ink-receiving layer.

### Ink for Inkjet Printing

In inkjet printing using an ultraviolet curable ink or a latex ink by which penetration into the ink-receiving layer does not occur or is less likely to occur, the sheet for inkjet printing of the present invention is effective for sufficiently ensuring printing density while suppressing uneven printing, and in inkjet printing using an ultraviolet curable ink, the sheet for inkjet printing is particularly effective for sufficiently ensuring printing density while suppressing uneven printing.

### Ultraviolet Curable Ink

The ultraviolet curable ink is ink that contains substantially no organic solvent and that is cured by irradiation of ultraviolet light. The ultraviolet curable ink contains a photopolymerizable monomer, a colorant which is a pigment or a dye, and a photopolymerization initiator that initiates a polymerization reaction.

In one aspect of the present invention, from the viewpoint of further improving adhesion between the ink-receiving layer and the printed portion, the ultraviolet curable ink preferably contains an acrylic-based monomer.

### Photopolymerizable Monomer

Examples of the photopolymerizable monomer include monofunctional acrylates, bifunctional acrylates, polyfunctional acrylates, and mixtures of these. Note that, as the photopolymerizable monomer, an acrylic monomer which is one of or a combination of these various acrylates may be used.

Examples of the monofunctional acrylate include hydroxypropyl acrylate, tetrahydrofurfuryl acrylate, phenol EO-modified (n=2) acrylate, 2-ethylhexyl EO-modified (n=2) acrylate, 2-hydroxy-3-phenoxypropyl acrylate, isobornyl acrylate, and acryloylmorpholine.

Examples of the bifunctional acrylate include hexanediol diacrylate, neopentyl glycol diacrylate, tripropylene glycol diacrylate, neopentyl glycol hydroxypivalate diacrylate, and bisphenol A EO-modified (n=4) diacrylate.

Examples of the polyfunctional acrylate include trimethylolpropane triacrylate, pentaerythritol triacrylate, trimethylolpropane PO-modified (n=3) triacrylate, ditrimethylolpropane tetraacrylate, pentaerythritol tetraacrylate, dipentaerythritol pentaacrylate, and dipentaerythritol hexaacrylate.

### Colorant

The ultraviolet curable ink typically contains a colorant.

As the colorant, various dyes, various pigments, and the like can be used.

### Photopolymerization Initiator

The photopolymerization initiator is generally a substance that initiates a polymerization reaction through irradiation with ultraviolet light. As such a photopolymerization initiator, for example, one agent or a mixture of multiple agents of photopolymerization initiators may be used, and a combination of a photopolymerization initiator and a photosensitizer may be used. For example, the photopolymerization initiator may be a combination of multiple photopolymerization initiators with different excitation wavelengths or a substance obtained by adding a photosensitizer to this.

### Other Components

As other components, for example, various known dispersants, stabilizers, surfactants, and the like may be further blended as necessary.

### Latex Ink

The latex ink contains a liquid dispersion medium and a dispersoid made of a material containing at least a resin, the material being dispersed (emulsified and/or suspended) in the dispersion medium.

### Resin

The resin contained in the latex ink is not particularly limited, and examples thereof include a vinyl resin, an acrylic resin, a styrene resin, an alkyd resin, a polyester resin, a polyurethane resin, an epoxy resin, a phenoxy resin, a polyolefin resin, and modified resins thereof (for example, modified resins modified to be water-soluble), and one or more selected therefrom can be used in combination.

### Dispersion Medium

The latex ink contains water as a dispersion medium.

### Colorant

The latex ink usually contains a colorant.

As the colorant, various dyes, various pigments, and the like can be used.

### Other Components

The latex ink may contain components besides those described above (other components).

Examples of such a component include a dispersant, an antifungal agent, a rust inhibitor, a pH adjuster, a surfactant, a plasticizer, an ultraviolet absorber, and a light stabilizer.

### Method for Forming Printed Portion

The printed portion by ink for inkjet printing is formed by providing ink for inkjet printing on the ink-receiving layer of the sheet for inkjet printing by an inkjet printing method.

Examples of the ink jet method include a piezo system and a thermal jet system.

When ultraviolet curable ink is provided as ink for inkjet printing, the ultraviolet exposure dose of the ultraviolet curable ink is not particularly limited and is preferably from 40 J/m² to 400 J/m².

When latex ink is provided as ink for inkjet printing, the heating temperature of the latex ink is not particularly limited and is preferably from 40° C. to 90° C.

By the method described above, a printed article having a printed portion in which the printing density is sufficiently ensured while suppressing uneven printing by ink for inkjet printing on the ink-receiving layer of the sheet for inkjet printing can be obtained.

Note that the sheet for inkjet printing according to an embodiment of the present invention can suppress uneven printing even in inkjet printing performed particularly with a reduced ink amount. Specifically, even in a case in which the total amount of ink is from 10% to 70% (preferably from 10% to 50%, and more preferably from 15% to 40%), a printed portion in which the printing density is sufficiently ensured while suppressing uneven printing can be formed.

### Sheet For Inkjet Printing Applications, Etc.

The sheet for inkjet printing according to an embodiment of the present invention is to be used for printing using ink for inkjet printing.

According to an embodiment of the present invention, provided is a method of use of the sheet for inkjet printing described above, which includes forming a printed portion on an ink-receiving layer of the sheet for inkjet printing by using an ink for inkjet printing.

According to an embodiment of the present invention, provided is a method for producing a printed article, the method including forming a printed portion on an ink-receiving layer of the sheet for inkjet printing described above by using an ink for inkjet printing.

Furthermore, according to an embodiment of the present invention, provided is a printed article having a printed portion by ink for inkjet printing on the ink-receiving layer of the sheet for inkjet printing described above.

Note that inkjet printing using ultraviolet curable ink or latex ink is employed in the method of use, the method for producing a printed article, and the printed article according to an aspect of the present invention. Moreover, because the method of use, the method for producing a printed article, and the printed article according to the present invention use the above-described sheet for inkjet printing of the present invention, a printed portion can be formed in which the printing density is sufficiently ensured while suppressing uneven printing, even in inkjet printing using ultraviolet curable ink or latex ink by which penetration into the ink-receiving layer does not occur or is less likely to occur.

In particular, among ultraviolet curable inks and latex inks, an ultraviolet curable ink may be suitably used.

Furthermore, in the method of use, the method for producing a printed article, and the printed article according to an aspect of the present invention, the total amount of ink during inkjet printing is not particularly limited, but the effect of the present invention is more easily exhibited when the total amount thereof is preferably from 10% to 70%, more preferably from 10% to 50%, and even more preferably from 15% to 40%.

According to the method of use, the method for producing a printed article, and the printed article according to an aspect of the present invention, printing density is sufficiently ensured while suppressing uneven printing, even with the amount of ink described above. Thus, this is useful for printing with the difference of density or gradation expression.

### EXAMPLES

The present invention will be specifically described with reference to Examples below, but the present invention is not limited to the following Examples.

### Examples 1 to 12 and Comparative Examples 1 to 4

Sheets for inkjet printing were prepared for Examples 1 to 12 and Comparative Examples 1 to 4 by the following procedures.

### Preparation of Composition for Forming Ink-Receiving Layer

A composition for forming the ink-receiving layer was prepared in accordance with each of the compositions described in Table 1.

Details of the raw materials used in the preparation of each of the compositions for forming the ink-receiving layer are presented below.

### Energy Ray-Curable Compound (A)

“Compound 1”: Ethylene oxide-modified hexa-functional polyglycerin acrylate (the polyol compound is an ethylene oxide-modified product of polyglycerin (a tetramer of glycerin) and is a complete ester having six acryloyl groups; and the number of moles of ethylene oxide is 6).
“Compound 2”: Ethylene oxide-modified dipentaerythritol hexaacrylate (the polyol compound is an ethylene oxide-modified product of dipentaerythritol and is a complete ester having six acryloyl groups; and the number of moles of ethylene oxide is 12).
“Compound 3”: Ethylene oxide-modified pentaerythritol tetraacrylate (the polyol compound is an ethylene oxide-modified product of pentaerythritol and is a complete ester having four acryloyl groups; and the number of moles of ethylene oxide is 35).
“Compound 4”: Dipentaerythritol pentaacrylate (the polyol compound is dipentaerythritol and is a partial ester having five acryloyl groups; and the hydroxyl value is 90 mgKOH/g).
“Compound 5”: Glycerin diacrylate (the polyol compound is glycerin and is a partial ester having two acryloyl groups; and the hydroxyl value is 240 mgKOH/g).
“Compound 6”: Ethylene oxide-modified sorbitol diacrylate (the polyol compound is an ethylene oxide-modified product of sorbitol and is a partial ester having two acryloyl groups; and the number of moles of ethylene oxide is 6).
“Compound 7”: Dipentaerythritol hexaacrylate (the polyol compound is dipentaerythritol and is a complete ester having six acryloyl groups; and the hydroxyl value is 10 mgKOH/g).

Each of the compounds 1 to 7 corresponds to an ester of a polyol compound and (meth)acrylic acid.

The compound 1 further satisfies the requirement (X2) and the requirement (X3) described above.

The compound 2 further satisfies the requirement (X2) described above.

The compound 3 further satisfies the requirement (X2) described above.

The compound 4 further satisfies the requirement (X1) described above.

The compound 5 further satisfies the requirement (X1) and the requirement (X3) described above.

The compound 6 further satisfies the requirement (X1) and the requirement (X2) described above.

### Silicone-Based Leveling Agent (B)

Polyether-modified silicone oil

### Filler (C)

Organosilica sol (particle size from 70 to 100 nm)

### Photopolymerization Initiator (D)

2-hydroxy-1-{4-[4-(2-hydroxy-2-methyl-propionyl)-benzyl]-phenyl}-2-methylpropan-1-one

The composition for forming an ink-receiving layer having the composition (blending amount in terms of the active component) described in Table 1 was diluted with a diluent solvent (ethyl acetate) to form a coating solution having an active component concentration of 30 mass %, and the coating solution thereof was then supplied for production of a sheet for inkjet printing.

### Production of Sheet for Inkjet Printing

The prepared composition for forming an ink-receiving layer was applied to one surface of a base material made of polyethylene terephthalate (thickness: 50 μm) using a bar coater such that the film thickness after drying was 2.5 μm.

Next, the solvent contained in the composition for forming an ink-receiving layer and applied to the base material was removed by heating at 70° C. for 1 minute using a hot air drying apparatus, after which the composition was irradiated with ultraviolet rays having a peak wavelength at 365 nm at a cumulative dose of 90 mJ/cm², and an ink-receiving layer was thereby formed.

Subsequently, a release liner (thickness: 50 μm) having a silicone-based release agent layer provided on one side of a poly(ethylene terephthalate) sheet was prepared, and an acrylic pressure sensitive adhesive was coated onto the silicone-based release agent layer side of the release liner at an amount such that the film thickness after drying was 20 μm. The solvent contained in the coating solution was then removed by heating at 90° C. for 1 minute using a hot air drying apparatus, and thereby an acrylic pressure sensitive adhesive layer was formed.

Then, the acrylic pressure sensitive adhesive layer formed on the release liner and a surface, which was opposite to the ink-receiving layer, of the base material were bonded, and thus a sheet for inkjet printing was obtained.

### Evaluation

Evaluations described in the following (1) to (4) were carried out.

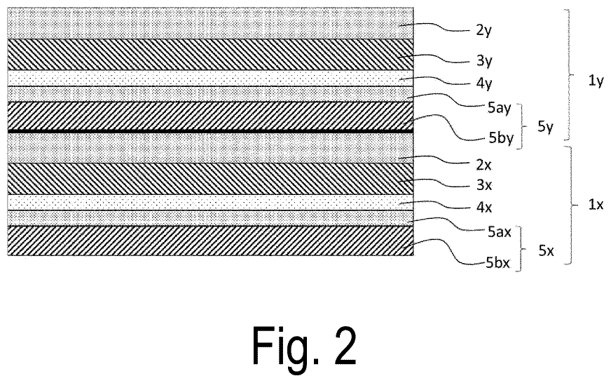

Note that to carry out the following evaluations (2) and (3), a pretreatment described below was implemented on the assumption of contact between the release liner back surface and the ink-receiving layer due to rolling of the sheet for inkjet printing. That is, two sheets for inkjet printing that were identical were prepared. As illustrated in FIG. 2, a surface of an ink-receiving layer 2x of a sheet for inkjet printing 1x and a back surface of a release liner 5y of another sheet for inkjet printing 1y were brought into contact and stacked and were left standing in an environment at a temperature of 70° C. under an applied pressure of 20 kg/cm² for 12 hours.

### (1) Measurement of Water Contact Angle of Ink-Receiving Layer

The water contact angle of the ink-receiving layer (portion of the ink-receiving layer to which the ink for inkjet printing was applied) of each sheet for inkjet printing of Examples 1 to 12 and Comparative Examples 1 to 4 was measured using the DSA100S automatic contact-angle meter (available from Kruss Scientific Instruments, Inc.). The water contact angle was measured in an atmosphere of 23° C. and 50% RH by dripping 2 μL of water onto the ink-receiving layer, and the static contact angle was calculated by the θ/2 method.

### (2) Evaluation of Uneven Printing

On the ink-receiving layer surface of each of the sheets for inkjet printing of Examples 1 to 12 and Comparative Examples 1 to 4, printing was carried out by an inkjet method using an ultraviolet curable ink (LUS-170 available from Mimaki Engineering Co., Ltd.) and an inkjet printer (UCJV300 available from Mimaki Engineering Co., Ltd.) with a total ink amount of 20% including 5% each of CMYK, and a printed portion was thereby formed.

After completion of printing, the entire printed surface was visually observed and evaluated based on the following criteria.
A: No uneven printing was observed in the entire printed surface.
B: Slight uneven printing was observed in a part of the printed surface, but the uneven printing was not a big issue in terms of the printing quality.
C: The difference of density stood out in the entire printed surface, and uneven printing was remarkable.

### (3) Evaluation of Printing Density

On the ink-receiving layer surface of each of the sheets for inkjet printing of Examples 1 to 12 and Comparative Examples 1 to 4, printing was carried out by an inkjet method using an ultraviolet curable ink (LUS-170 available from Mimaki Engineering Co., Ltd.) and an inkjet printer (UCJV300 available from Mimaki Engineering Co., Ltd.) with an ink amount of 20% for the ink color Y, and a printed portion was thereby formed.

After completion of printing, the entire printed surface was visually observed and evaluated based on the following criteria.
A: Sufficient printing density was observed.
B: Although the printing density was slightly low, the printing density was not a big issue in terms of the printing quality.
C: The printing density was low.

### (4) Dynamic Frictional Force

The dynamic frictional force of the ink-receiving layer of each of the sheets for inkjet printing of Examples 1 to 12 against a stainless steel plate was measured in accordance with JIS K 7125:1999 at a surface load of 9.8 N and a test speed of 10 mm/min. The result was expressed as an “(average of minimum values of dynamic frictional force)−(average of maximum values of dynamic frictional force)”. A smaller maximum value of the dynamic frictional force means an improvement in the slipperiness of the ink-receiving layer.

The evaluation results are shown in Table 1.

TABLE 1

| | | Example | Example | Example | Example | Example | Example | Example | Example |
|---|---|---|---|---|---|---|---|---|---|
| | | 1 | 2 | 3 | 4 | 5 | 6 | 7 | 8 |
| Energy ray-curable | Compound 1 | 100 | — | — | — | — | — | 100 | 100 |
| compound (A) | Compound 2 | — | 100 | — | — | — | — | — | — |
| | Compound 3 | — | — | 100 | — | — | — | — | — |
| | Compound 4 | — | — | — | 100 | — | — | — | — |
| | Compound 5 | — | — | — | — | 100 | — | — | — |
| | Compound 6 | — | — | — | — | — | 100 | — | — |
| | Compound 7 | — | — | — | — | — | — | — | — |

| | | | | | | | | | |
|---|---|---|---|---|---|---|---|---|---|
| | Silicone-based leveling agent (B) | 0.04 | 0.04 | 0.04 | 0.04 | 0.04 | 0.04 | 0.04 | 0.04 |
| | Filler (C) | 80 | 80 | 80 | 80 | 80 | 80 | 0 | 40 |
| | Photopolymerization initiator (D) | 8 | 8 | 8 | 8 | 8 | 8 | 8 | 8 |
| Evaluation | Contact angle [°] | 76 | 72 | 60 | 76 | 74 | 72 | 72 | 74 |
| results | Uneven printing | A | A | A | A | A | A | A | A |
| | Printing density | A | A | A | A | A | A | A | A |
| | Dynamic frictional force [N] | 5.0-5.5 | 5.1-5.5 | 5.0-5.7 | 4.8-5.5 | 4.8-5.6 | 4.9-5.4 | 2.7-9.9 | 4.0-6.5 |

| | | | | | | Compar- | Compar- | Compar- | Compar- |
|---|---|---|---|---|---|---|---|---|---|
| | | Example | Example | Example | Example | ative | ative | ative | ative |
| | | 9 | 10 | 11 | 12 | Example 1 | Example 2 | Example 3 | Example 4 |
| Energy ray-curable | Compound 1 | 100 | 100 | 100 | 100 | 100 | — | — | — |
| compound (A) | Compound 2 | — | — | — | — | — | — | — | — |
| | Compound 3 | — | — | — | — | — | — | — | — |
| | Compound 4 | — | — | — | — | — | — | — | — |
| | Compound 5 | — | — | — | — | — | — | — | — |
| | Compound 6 | — | — | — | — | — | — | — | — |
| | Compound 7 | — | — | — | — | — | 100 | 100 | 100 |

| | | | | | | | | | |
|---|---|---|---|---|---|---|---|---|---|
| | Silicone-based leveling agent (B) | 0.01 | 0.02 | 0.05 | 0.06 | 0 | 0 | 0.04 | 0.04 |
| | Filler (C) | 80 | 80 | 80 | 80 | 0 | 0 | 0 | 80 |
| | Photopolymerization initiator (D) | 8 | 8 | 8 | 8 | 8 | 8 | 8 | 8 |
| Evaluation | Contact angle [°] | 71 | 73 | 78 | 79 | 57 | 69 | 81 | 86 |
| results | Uneven printing | B | A | A | A | C | C | A | A |
| | Printing density | A | A | A | B | A | A | C | C |
| | Dynamic frictional force [N] | 5.0-5.6 | 5.0-5.5 | 4.9-5.5 | 4.9-5.5 | — | — | — | — |

Results shown in Table 1 reveals the following.

From the results obtained in Examples 1 to 12, it is clear that when the water contact angle of the ink-receiving layer is 80° or less with the ink-receiving layer being formed from a composition for forming the ink-receiving layer, the composition thereof containing the specific energy ray-curable compound (A) and the silicone-based leveling agent (B), printing density can be sufficiently ensured while suppressing uneven printing.

In contrast, from the results obtained in Comparative Examples 1 and 2, it is clear that when the ink-receiving layer formed from a composition for forming an ink-receiving layer that does not contain the silicone-based leveling agent (B), while printing density can sufficiently be ensured, uneven printing cannot be suppressed.

In addition, as indicated by the results obtained in Comparative Examples 3 and 4, it is clear that when the water contact angle of an ink-receiving layer formed from a composition for forming an ink-receiving layer containing the energy ray-curable compound (A) and the silicone-based leveling agent (B) is 81° or greater, while uneven printing can be suppressed, printing density cannot be sufficiently ensured.

Furthermore, from a comparison of Examples 1 and 8 with Example 7, it is found that the addition of the filler (C) improves the slipperiness of the ink-receiving layer.

### REFERENCE SIGNS LIST

1, 1x, 1y: Sheet for inkjet printing
2, 2x, 2y: Ink-receiving layer
3, 3x, 3y: Base material
4, 4x, 4y: Pressure sensitive adhesive layer
5, 5x, 5y: Release liner
5a, 5ax, 5ay: Silicone-based release agent layer
5b, 5bx, 5by: Support

1. A sheet for inkjet printing, the sheet having a multilayer structure comprising an ink-receiving layer, a base material, a pressure sensitive adhesive layer, and a release liner in this order, the release liner comprising a silicone-based release agent layer on a contact face in contact with the pressure sensitive adhesive layer, the ink-receiving layer being a cured layer of a composition for forming an ink-receiving layer, the composition comprising an energy ray-curable compound (A) and a silicone-based leveling agent (B), the energy ray-curable compound (A) being an ester of a polyol compound and (meth)acrylic acid, and a water contact angle of the ink-receiving layer being 80° or less.

2. The sheet for inkjet printing according to claim 1, wherein the energy ray-curable compound (A) further satisfies one or more of the following requirements (X1) to (X3):
requirement (X1): the ester is a partial ester;
requirement (X2): the polyol compound constituting the ester is an alkylene oxide-modified product, provided that an alkylene group constituting the alkylene oxide-modified product has from 2 to 4 carbons; and
requirement (X3): the polyol compound constituting the ester has a glycerin skeleton.

3. The sheet for inkjet printing according to claim 1, wherein the composition for forming the ink-receiving layer further comprises a filler (C).

4. The sheet for inkjet printing according to claim 1, wherein the sheet is a rolled body obtained by rolling the sheet into a roll form, or is a wound body obtained by winding the sheet around a core material.

5. A method, comprising inkjet printing an ink on the ink-receiving layer of the sheet for inkjet printing according to claim 1.

6. A printed article produced by a method comprising forming a printed portion on the ink-receiving layer of the sheet for inkjet printing according to claim 1 with an ink for inkjet printing.

7. A printed article comprising a printed portion formed by an ink for inkjet printing, the printed portion being formed on the ink-receiving layer of the sheet for inkjet printing according to claim 1.
